(19) United States
(12) Patent Application Publication
(10) Pub. No.: US 2015/0065053 A1
(43) Pub. Date: Mar. 5, 2015

(54) METHOD OF CONTROLLING SHORT-RANGE WIRELESS COMMUNICATION AND APPARATUS SUPPORTING THE SAME

(71) Applicant: Samsung Electronics Co., Ltd., Suwon-si (KR)

(72) Inventors: Chihyun CHO, Suwon-si (KR); Kenhyung PARK, Suwon-si (KR); Hyunseok SHIN, Seongnam-si (KR); Changryong HEO, Suwon-si (KR)

(21) Appl. No.: 14/475,997

(22) Filed: Sep. 3, 2014

Related U.S. Application Data
(60) Provisional application No. 61/873,096, filed on Sep. 3, 2013.

(30) Foreign Application Priority Data
Jun. 9, 2014 (KR) 10-2014-0069625

(51) Int. Cl. H04W 4/00; H04W 76/02; H04W 8/00

(52) U.S. Cl. CPC H04W 4/008; H04W 8/005; H04W 76/023
USPC 455/41.2

(57) ABSTRACT

An electronic device for controlling short-range wireless communication is provided. The electronic device includes a short-range communication module configured to transmit/receive a short-range communication signal to/from at least one neighboring device and a control module configured to control, when a pairing connection with a first neighboring device is established through the short-range communication module, at least one of turning on/off of a scan operation for waiting for reception of a signal from at least one second neighboring device and configuring a cycle of the scan operation.

### CROSS-REFERENCE TO RELATED APPLICATION(S)

This application claims the benefit under 35 U.S.C. §119(e) of a U.S. Provisional application filed on Sep. 3, 2013 in the U.S. Patent and Trademark Office and assigned Ser. No. 61/873,096, and under 35 U.S.C. §119(a) of a Korean patent application filed on Jun. 9, 2014 in the Korean Intellectual Property Office and assigned Serial number 10-2014-0069625, the entire disclosure of each of which is hereby incorporated by reference.

### TECHNICAL FIELD

The present disclosure relates to a method of controlling short-range wireless communication and an apparatus supporting the same.

### BACKGROUND

Recently, electronic devices support executions of various functions based on the development of hardware and communication technologies. Particularly, the electronic devices support the performance of a directional communication connection between electronic devices through a communication function mounted thereto. For example, the electronic devices support various short-range wireless communication technologies to implement bidirectional communication with low power consumption and low costs. Among the short-range wireless communication technologies, a Bluetooth communication scheme has increased a utilization range thereof because the short-range wireless communication can be formed with lower costs and low power consumption compared to other short-range wireless communication schemes.

The above information is presented as background information only to assist with an understanding of the present disclosure. No determination has been made, and no assertion is made, as to whether any of the above might be applicable as prior art with regard to the present disclosure.

### SUMMARY

Meanwhile, in order to perform short-range communication such as Bluetooth communication, the electronic device should pass through a set up process for a communication connection. Particularly, the electronic device which informs neighboring devices of the existence of itself operates in a scan mode in which the electronic device periodically wakes up and waits for reception of a communication signal. In this case, because the electronic device periodically operates in the scan mode in a state in which a communication connection schedule is not clear, power of the electronic device may be unnecessarily consumed.

Particularly, an accessory electronic device or a wearable electronic device having a Bluetooth function has a limited power capacity.

Aspects of the present disclosure are to address at least the above-mentioned problems and/or disadvantages and to provide at least the advantages described below. Accordingly, an aspect of the present disclosure is to provide a method of minimizing power consumption generated in the communication connection.

In accordance with an aspect of the present disclosure, an electronic device is provided. The electronic device includes a short-range communication module configured to transmit/receive a short-range communication signal to/from at least one neighboring device, and a control module configured to control, when a pairing connection with a first neighboring device is established through the short-range communication module, turning on/off of a scan operation for waiting for reception of a signal from at least one second neighboring device and configuring a cycle of the scan operation.

In accordance with another aspect of the present disclosure, a method of controlling a short-range communication connection by an electronic device is provided. The method includes establishing a pairing connection with a first neighboring device and generating at least one of a control to stop a scan operation for waiting for reception of a signal from at least one second neighboring device, and a control to configure a cycle of the scan operation when the pairing connection with the first neighboring device is established.

In accordance with another aspect of the present disclosure, an electronic device is provided. The electronic device includes a short-range communication module configured to transmit/receive a short-range communication signal to/from at least one neighboring device and a control module configured to control, when a pairing connection with a first neighboring device is established through the short-range communication module, at least one of turning on/off of a broadcasting operation of broadcasting a signal to search for a neighboring device and configuring a cycle of the broadcasting operation.

In accordance with another aspect of the present disclosure, a method of controlling a short-range communication connection by an electronic device is provided. The method includes establishing a pairing connection with a first neighboring device and at least one of stopping a broadcasting operation of broadcasting an inquiry signal to search for a neighboring device and controlling a cycle of the broadcasting operation when the pairing connection with the first neighboring device is established.

According to various embodiments, when an electronic device is paired with another electronic device, the electronic device may make a control to stop a scan operation in which the electronic device waits for reception of a signal from the neighboring electronic device or a broadcasting operation of broadcasting a signal. When the electronic device is paired with another electronic device, the electronic device may control a cycle of the scan or broadcasting operation, thereby minimizing power consumption unnecessarily generated due to a search standby (inquiry scan) or connection standby (page scan).

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 is a block diagram of a communication configuration control module according to various embodiments of the present disclosure;

FIG. 3 illustrates operations of signal flows between devices for a communication control according to various embodiments of the present disclosure;

FIG. 4 is a flowchart illustrating a communication control method according to various embodiments of the present disclosure;

FIG. 5 is a flowchart illustrating a communication control method according to various embodiments of the present disclosure;

FIG. 6 is a flowchart illustrating a communication control method according to various embodiments of the present disclosure;

FIG. 7 schematically illustrates a configuration of a communication control system according to various embodiments of the present disclosure;

FIG. 8 is a block diagram of an electronic device according to various embodiments of the present disclosure; and

FIG. 9 illustrates communication protocols among a plurality of electronic devices according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or” “have” may be construed to denote a certain characteristic, number, operation, constituent element, component or a combination thereof, but may not be construed to exclude the existence of or a possibility of addition of one or more other characteristics, numbers, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” and/or the like, may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of the first user device and the second user device are user devices. For example, a first element could be termed a second element, and similarly, a second element could be also termed a first element without departing from the scope of the present disclosure.

In the case according to which a component is referred to as being “connected” or “accessed” to other component, it should be understood that not only the component is directly connected or accessed to the other component, but also there may exist another component between the component and the other component. Meanwhile, in the case according to which a component is referred to as being “directly connected” or “directly accessed” to other component, it should be understood that there is no component therebetween. The terms used in the present disclosure are only used to describe specific various embodiments, and are not intended to limit the present disclosure. As used herein, the singular forms are intended to include the plural forms as well, unless the context clearly indicates otherwise. Singular forms are intended to include plural forms unless the context clearly indicates otherwise.

An electronic device according to the present disclosure may be a device including a communication function. For example, the device corresponds to a combination of at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player, a mobile medical device, an electronic bracelet, an electronic necklace, an electronic accessory, a camera, a wearable device, an electronic clock, a wrist watch, home appliances (e.g., an air-conditioner, vacuum, an oven, a microwave, a washing machine, an air cleaner, and/or the like), an artificial intelligence robot, a TeleVision (TV), a Digital Video Disk (DVD) player, an audio device, various medical devices (e.g., Magnetic Resonance Angiography (MRA), Magnetic Resonance Imaging (MRI), Computed Tomography (CT), a scanning machine, an ultrasonic wave device, and/or the like), a navigation device, a Global Positioning System (GPS) receiver, an Event Data Recorder (EDR), a Flight Data Recorder (FDR), a set-top box, a TV box (e.g., Samsung HomeSync™, Apple TV™, or Google TV™), an electronic dictionary, vehicle infotainment device, an electronic equipment for a ship (e.g., navigation equipment for a ship, gyrocompass, and/or the like), avionics, a security device, electronic clothes, an electronic key, a camcorder, game consoles, a Head-Mounted Display (HMD), a flat panel display device, an electronic frame, an electronic album, furniture or a portion of a building/structure that includes a communication function, an electronic board, an electronic signature receiving device, a projector, and/or the like. It is obvious to those skilled in the art that the electronic device according to the present disclosure is not limited to the aforementioned devices.

According to various embodiments of the present disclosure, an electronic device supporting short-range communication may support a master-single slave connection, a master-multi slave connection, and a scatternet connection. The electronic device may be a device restrictively operated by the master-single slave connection, for example, a wearable device or an accessory electronic device, but the electronic device of the present disclosure is not limited thereto.

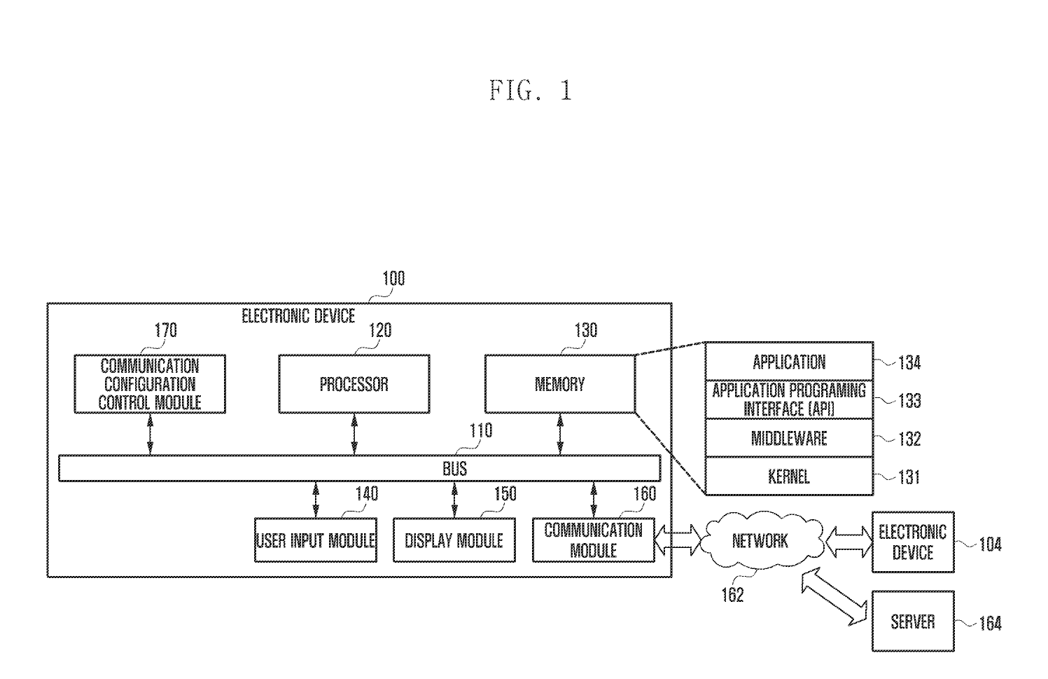

FIG. 1 is a block diagram illustrating a configuration of an electronic device according to an embodiment of the present disclosure.

Referring to FIG. 1, the electronic device 100 may include a bus 110, a processor 120, a memory 130, a user input module 140, a display module 150, a communication module 160, a communication configuration control module 170 and other similar and/or suitable components.

The bus 110 may be a circuit which interconnects the above-described elements and delivers a communication (e.g. a control message) between the above-described elements.

The processor 120 may receive commands from the above-described other elements (e.g., the memory 130, the user input module 140, the display module 150, the communication module 160, the communication configuration control module 170, and/or the like) through the bus 110, may interpret the received commands, and may execute calculation or data processing according to the interpreted commands.

The memory 130 may store commands or data received from the processor 120 or other elements (e.g., the user input module 140, the display module 150, the communication module 160, and/or the like) or generated by the processor 120 or the other elements. The memory 130 may include programming modules, such as a kernel 131, a middleware 132, an Application Programming Interface (API) 133, an application 134, and/or the like. Each of the above-described programming modules may be implemented in software, firmware, hardware, or a combination of two or more thereof.

The kernel 131 may control or manage system resources (e.g., the bus 110, the processor 120, the memory 130, and/or the like) used to execute operations or functions implemented by other programming modules (e.g., the middleware 132, the API 133, and the application 134). In addition, the kernel 131 may provide an interface capable of accessing and controlling or managing the individual elements of the electronic device 100 by using the middleware 132, the API 133, or the application 134.

The middleware 132 may serve to go between the API 133 or the application 134 and the kernel 131 in such a manner that the API 133 or the application 134 communicates with the kernel 131 and exchanges data therewith. For example, the middleware 132 may be configured to be an intermediary for communication between the API 133 or the application 134 and the kernel 131. In addition, in relation to work requests received from one or more applications 134 and/or the middleware 132, for example, may perform load balancing of the work requests by using a method of assigning a priority, in which system resources (e.g. the bus 110, the processor 120, the memory 130, and/or the like) of the electronic device 100 can be used, to at least one of the one or more applications 134.

The API 133 is an interface through which the application 134 is capable of controlling a function provided by the kernel 131 or the middleware 132, and may include, for example, at least one interface or function for file control, window control, image processing, character control, and/or the like.

The applications 134 may include, for example, a home application, a dialer application, a Short Message Service (SMS)/Multimedia Message Service (MMS) application, an Instant Message (IM) application, a browser application, a camera application, an alarm application, a contact application, a voice dial application, an electronic mail (e-mail) application, a calendar application, a media player application, an album application, a clock application, and any other suitable and/or similar application.

The user input module 140, for example, may receive a command or data as input from a user via input-output means (e.g., sensor, keyboard, touchscreen, and/or the like) and may deliver the received command or data to the processor 120 or the memory 130 through the bus 110. The display module 150 may display a video, an image, data, and/or the like to the user.

The display module 150 may display the received various information (e.g., multi-media data, text data) from the above-described elements.

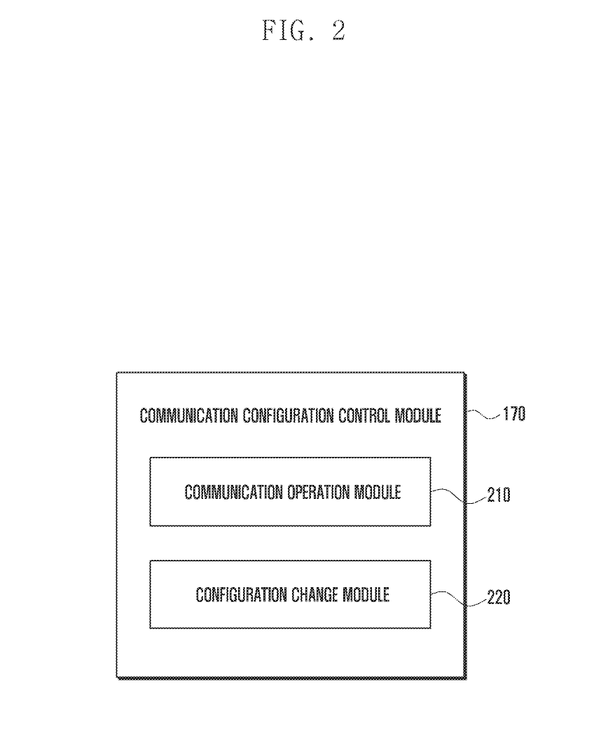

The communication configuration control module 170 may control a short-range communication connection with another electronic device. When the electronic device 100 is paired with another electronic device, the communication configuration control module 170 may make a control to stop a scan operation of waiting for reception of a signal from a neighboring electronic device or a broadcasting operation of broadcasting a signal. For example, in response to the electronic device 100 being paired with another electronic device, the communication configuration control module 170 may control to stop a scan operation of waiting for reception of a signal from a neighboring electronic device or a broadcasting operation of broadcasting a signal. When electronic device 100 is paired with another electronic device, the communication configuration control module 170 may control a cycle of the scan or broadcasting operation. Additional information on the communication configuration control module 170 is provided through FIG. 2 described below.

According to various embodiments of the present disclosure, the electronic device 100 may communicate with another electronic device using the communication module 160. For example, the communication module 160 may communicate with another electronic device 104, a server 164, and/or the like. The communication module 160 may communicate with the other electronic device 104, the server 165, and/or the like directly or through a network 162. For example, the communication module 160 may operate to connect the electronic device 100 to the network 162.

FIG. 2 is a block diagram of a communication configuration control module of an electronic device according to various embodiments of the present disclosure.

Referring to FIG. 2, the communication configuration control module 170 may include a communication operation module 210 and a configuration change module 220. The communication configuration control module 170 may be included in the processor 120 (of FIG. 1). According to various embodiments of the present disclosure, the processor 120 may perform operations of the communication configuration control module 170 described below.

The communication operation module 210 may control the operation of the short-range communication module. When a low power mode-based Bluetooth communication function activation request input is made (e.g., in response to receiving the activation request), the communication operation module 210 may activate the short-range communication module. For Bluetooth communication, the communication operation module 210 may maintain the short-range communication module (e.g., a Bluetooth communication module) in a turn-on state on a predetermined cycle, for example, maintaining the performance of the scan operation. In the scan operation, the electronic device may be in a signal standby state. The communication operation module 210 may maintain the Bluetooth communication module in an active state for a predefined time on predetermined cycle, and maintain the Bluetooth module in a standby state when the predefined time passes.

When a search (inquiry) signal is received during the scan operation, the communication operation module 210 may provide a search response signal in response to the inquiry signal to another electronic device which transmitted the inquiry signal. When a page signal is received during the scan operation, the communication operation module 210 may provide PIN code information for authenticating a connection to another electronic device having transmitted the page signal in response to the page signal. When the connection authentication is completed, the communication operation module 210 may support data transmission/reception with another paired electronic device through a communication channel formed based on Bluetooth communication.

According to various embodiments of the present disclosure, when the electronic device 100 is configured as a master device, the communication operation module 210 may support a neighbor inquiry function. The communication operation module 210 may broadcast an inquiry signal for making a request for identification information to another electronic device which can be connected through Bluetooth. The communication operation module 210 may construct (e.g., generate) an inquiry list based on information on one or more slave devices included in an inquiry response signal transmitted by another electronic device. When the inquiry response signal is received from one or more other electronic devices (e.g., in response to receiving the inquiry response signal), the communication operation module 210 may transmit a page signal to another electronic device having transmitted the inquiry response signal. When the page response signal is received (e.g., in response to receiving the page response signal), the communication operation module 210 may determine whether PIN code information included in the page response signal is effective. When the PIN code information is effective (e.g., in response to determining that the PIN code information is effective), the communication operation module 210 may be paired with another electronic device having transmitted the page response signal.

When the electronic device is paired with another electronic device, the configuration change module 220 may control on/off of the scan operation or the scan cycle. For example, when the electronic device is paired with another electronic device (e.g., in response to the electronic device being paired with another electronic device), the configuration change module 220 may make a control to stop the scan function and configure the scan cycle to be longer than a pre-configured cycle. For example, when the electronic device is paired with another electronic device (e.g., in response to the electronic device being paired with another electronic device), the configuration change module 220 may make a control to not respond to an inquiry signal of a neighboring electronic device.

According to various embodiments of the present disclosure, when the electronic device is paired with another electronic device, the configuration change module 220 may determine whether the paired electronic device is a preset private device. When the paired electronic device is the private device (e.g., in response to determining that the paired electronic device is the preset private device), the configuration change module 220 may control on/off of the scan operation or the scan cycle. The configuration change module 220 may determine whether the private device is connected, by comparing identification information of the preset private device and identification information of the paired communication device. The private device may be configured by a user's selection or configured when the private device is manufactured. For example, a designer of the electronic device may design the electronic device to include identification information of the private device when manufacturing the electronic device.

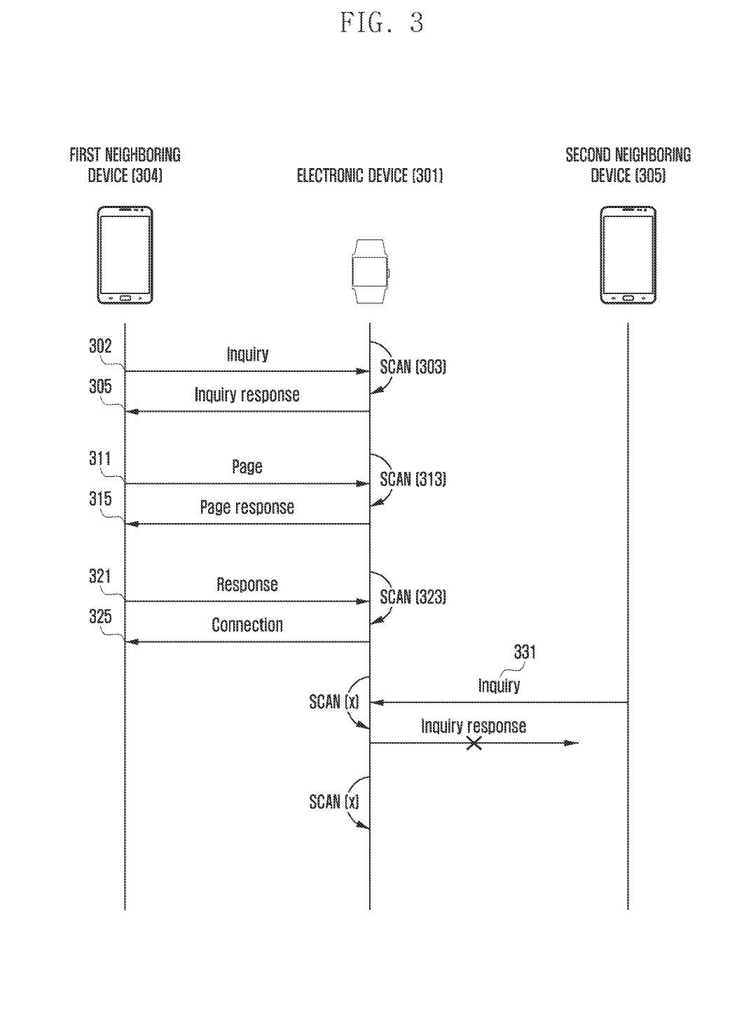

FIG. 3 illustrates operations of signal flows between devices for a communication control according to various embodiments of the present disclosure.

Referring to FIG. 3, at operation 302, a first neighboring device 304 may broadcast an inquiry signal to discover a connectable neighboring device. The electronic device 301 may determine whether a signal transmitted is by a neighboring device for a predetermined time by performing a scan operation on a predetermined cycle.

At operation 303, the electronic device 301 may perform the scan operation of waiting for reception of a signal. According to various embodiments of the present disclosure, the electronic device 301 may receive an inquiry signal based on Bluetooth communication. According to various embodiments of the present disclosure, the electronic device 301 may receive an inquiry signal based on another wireless communication technology.

At operation 305, in response to the electronic device 301 receiving an inquiry signal transmitted by the first neighboring device 304 during the scan operation, the electronic device 301 may transmit an inquiry response signal to the first neighboring device 304. The inquiry response signal may include an address of the electronic device 301 and clock information. For example, when the electronic device 301 receives the inquiry signal (e.g., in response to the electronic device 301 receiving the inquiry signal), the electronic device 301 may transmit inherent information of the Bluetooth communication module, for example, MAC address information and predefined its own inherent identification information to the first neighboring device. The inherent identification information may include at least one of Bluetooth address information of the electronic device 301, Bluetooth MAC address information, Bluetooth name information of the electronic device 301, and inherent hardware information assigned to the electronic device 301.

Meanwhile, when the first neighboring device 304 receives the inquiry response signal from the electronic device 301 (e.g., in response to the first neighboring device 304 receiving the inquiry response signal), the first neighboring device 304 may construct (e.g., generate) and output an inquiry list based on the inquiry response signal.

At operation 311, when the inquiry response signal is transmitted (e.g., in response to transmission of the inquiry response signal), the first neighboring device 304 may transmit a connection request signal, for example, a page signal to the electronic device 301. When a time corresponding to a preset cycle arrives, the electronic device may maintain the Bluetooth communication module in an active state on a predetermined cycle to support a response standby state for the communication signal.

At operation 313, the electronic device 301 may perform the scan operation of waiting for reception of the page signal and receive the page signal transmitted by the first neighboring device.

At operation 315, when the electronic device 301 receives the page signal based on the Bluetooth communication from the first neighboring device 304 during the scan operation (e.g., in response to the electronic device 301 receiving the page signal), the electronic device 301 may transmit a page response signal to the first neighboring device 304. The page response signal may include PIN code information.

At operation 321, when the PIN code included in the page response signal matches the stored PIN code information (e.g., in response to determining that the PIN code included in the page response signal matches the stored PIN code information), the first neighboring device 304 may transmit a response signal indicating that the connection authentication is completed to the electronic device 301. For example, the first neighboring device 304 may determine whether the transmitted PIN code information is effective information by comparing the PIN code information with the PIN code information configured in the first neighboring device 304. When the PIN code information is not effective (e.g., in response to determining that the PIN code information is not effective), the first neighboring device 304 may inform of non-matching of the information or stop the process later.

When a time corresponding to a preset cycle arrives, the electronic device 301 may maintain the Bluetooth communication module in an active state on a predetermined cycle to support a response standby state for the communication signal.

At operation 323, the electronic device 301 may receive a response signal during the scan operation.

At operation 325, when the connection authentication is completed (e.g., in response to completion of the connection authentication), the first neighboring device 304 and the electronic device 301 may be paired with each other.

At operation 331, the electronic device 301 may receive an inquiry signal from a second neighboring device 305 in a state in which the electronic device 301 and the first neighboring device 304 are paired with each other. When the electronic device 301 is paired with the first neighboring device 304, the electronic device 301 may not transmit a response signal corresponding to a response to the inquiry signal of the second neighboring device 304.

When the electronic device 301 is paired with the first neighboring device 304, the electronic device 301 may stop the scan operation performed on a predetermined cycle or control the cycle of the scan operation.

According to various embodiments of the present disclosure, the electronic device may operate in the form dependent on a particular electronic device and a neighboring device paired with the electronic device may restrictively operate by a master-single slave connection therebetween. For example, the electronic device may operate similar to a wearable device, an accessory electronic device, and/or the like.

According to various embodiments of the present disclosure, when the pairing between a slave device (e.g., the electronic device 301) and a first master device corresponding to a private device is released (e.g., in response to release of the pairing between the slave device and the first master device), the slave device may make a control to again turn on the scan operation for the inquiry standby (inquiry scan).

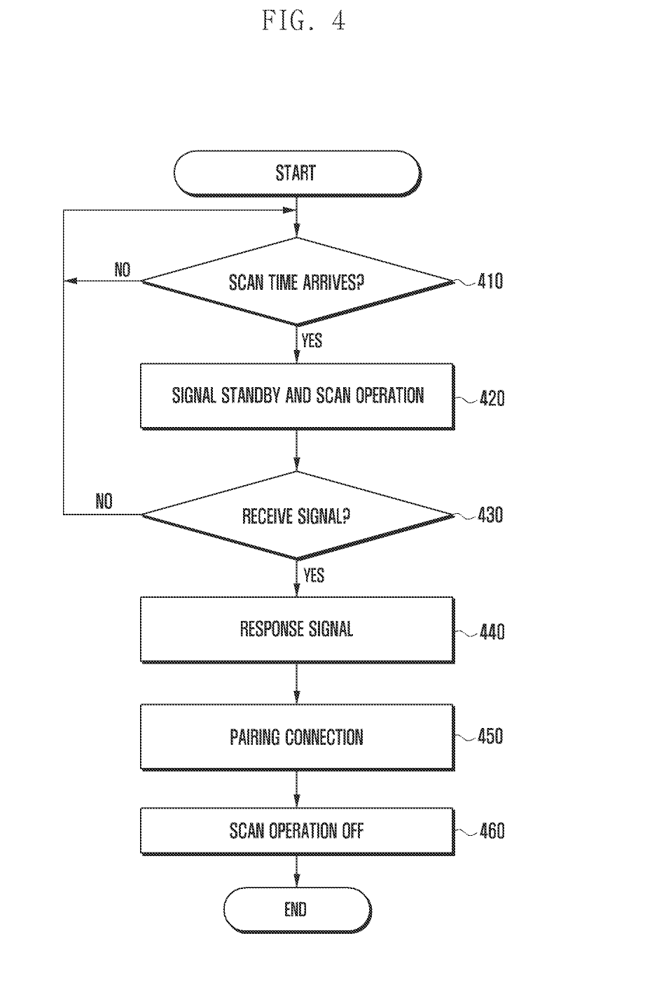

FIG. 4 is a flowchart illustrating a communication control method according to various embodiments of the present disclosure.

Referring to FIG. 4, at operation 410, the electronic device may determine whether a scan time arrives. The scan refers to a signal standby state for waiting for reception of a signal.

If the electronic device determines that the scan time does not arrive at operation 410, then the electronic device may continue to poll for an indication that the scan time arrives.

In contrast, if the electronic device determines that the scan time arrives at operation 410, then the electronic device may proceed to operation 420 at which the electronic device may perform the scan operation to wait for an inquiry signal based on Bluetooth communication or a page signal for a connection request. For example, the electronic device may perform the scan operation by activating the Bluetooth communication module for a predefined time on a predetermined cycle, and maintain the Bluetooth module in a standby state when the predefined time passes.

At operation 430, the electronic device may determine whether the inquiry signal or the page signal is received from the neighboring device.

If the electronic device determines that the inquiry single or the page signal is not received from the neighboring device at operation 430, then the electronic device may proceed to operation 410. For example, if neither the inquiry signal nor the page signal is received from the neighboring device, then the electronic device may return to operation 410.

In contrast, if the electronic device determines that the inquiry signal or the page signal is received at operation 430, then the electronic device may proceed to operation 440 at which the electronic device may transmit a response signal to the neighboring device having transmitted the inquiry signal or the page signal in response to the inquiry signal or the page signal.

At operation 450, the electronic device may determine effective information according to a pairing response signal with the neighboring device and may be paired with the neighboring device. For example, at operation 450, the pairing connection between the electronic device and the neighboring device may be established.

At operation 460, the electronic device may turn the scan operation off. For example, when the electronic device is paired with the neighboring device, the electronic device may stop the scan operation or control a scan cycle. For example, when the electronic device is paired with one neighboring device, the electronic device may turn off a scan function to stop the scan operation. The electronic device may configure the scan cycle of the scan operation to be relatively longer than a pre-configured scan cycle.

According to various embodiments of the present disclosure, when the electronic device is paired with one neighboring device (e.g., in response to the electronic device being paired with a neighboring device), the electronic device may make a control to not transmit a response signal corresponding to a response to an inquiry signal of another neighboring device.

According to various embodiments of the present disclosure, when the pairing connection between the electronic device and one neighboring device is released (e.g., in response to release of the pairing connection between the electronic device and the one neighboring device), the electronic device may again turn on the scan operation to operate on a predetermined cycle.

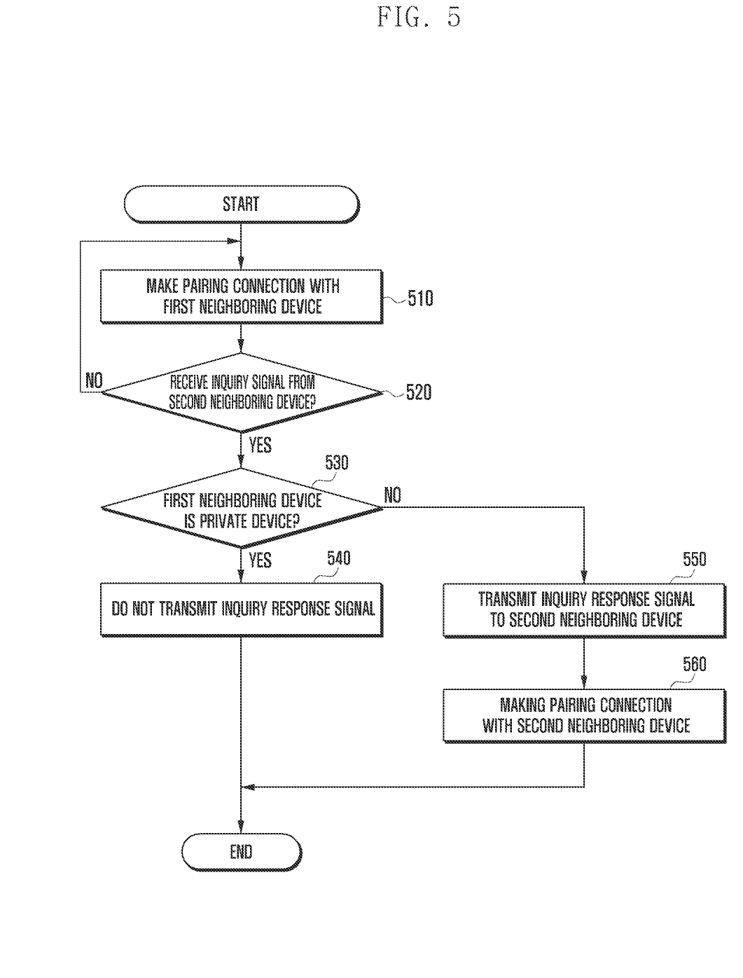

FIG. 5 is a flowchart illustrating a communication control method according to various embodiments of the present disclosure.

Referring to FIG. 5, at operation 510, the electronic device may be paired with a first neighboring device.

At operation 520, the electronic device may determine whether an inquiry signal is received from a second neighboring device. For example, the electronic device may determine whether an inquiry signal is received from a second neighboring device by performing a scan operation on a predetermined cycle in a state in which the electronic device is paired with the first neighboring device.

If the electronic device determines that the inquiry signal is not received from the second neighboring device at operation 520, then the electronic device may return to operation 510 and maintain a pairing connection with the first neighboring device.

In contrast, if the electronic device determines that the inquiry signal is received from the second neighboring device at operation 520, then the electronic device may proceed to operation 530 at which the electronic device determines whether the first neighboring device is a preset private device. For example, if the inquiry signal is received from the second neighboring device in the state in which the electronic device is paired with the first neighboring device, the electronic device may determine whether the paired first neighboring device is a preset private device.

If the electronic device determines that the first neighboring device is the preset private device at operation 530, then the electronic device may proceed to operation 540 at which the electronic device controls to not transmit an inquiry response signal. For example, if the paired first neighboring device is the preset private device, the electronic device may make a control to not transmit an inquiry response signal which is a response to the inquiry signal at operation 540.

According to various embodiments of the present disclosure, when the paired first neighboring device is the preset private device, the electronic device may stop the scan operation performed on a predetermined cycle or control the cycle of the scan operation.

In contrast, if the electronic device determines that the first neighboring device is not the preset private device at operation 530, then the electronic device may proceed to operation 550 at which the electronic device may transmit an inquiry response signal to a second neighboring device. For example, the first neighboring device is not the preset private device, the electronic device may transmit the inquiry response signal which is the response to the inquiry signal to the second neighboring device at operation 550. Thereafter, electronic device may proceed to operation 550.

At operation 560, the electronic device may establish a pairing connection with the second neighboring device. For example, the electronic device may receive a page signal from the second neighboring device having transmitted the inquiry response signal, transmit a page response signal corresponding to a response to the page signal, and perform an authentication process, so as to be paired with the second neighboring device.

When the first paired first neighboring device is the preset private device, the electronic device may make a control to stop the any further scan operation without transmitting the inquiry response signal which is the response to the inquiry signal transmitted by the first neighboring device, thereby reducing unnecessary power consumption generated due to a connection request standby.

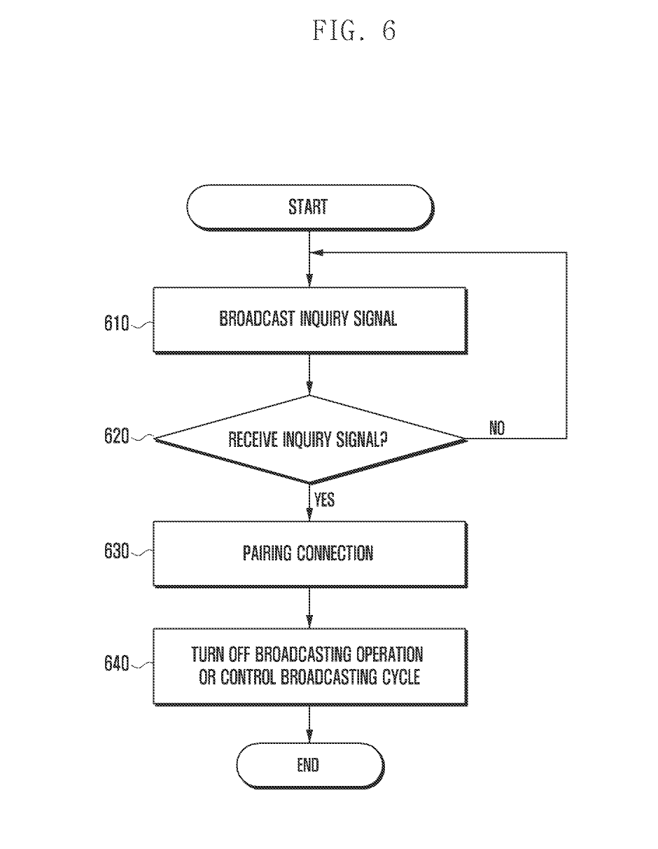

FIG. 6 is a flowchart illustrating a communication control method according to various embodiments of the present disclosure.

Referring to FIG. 6, at operation 610, the electronic device may broadcast an inquiry signal to discover a connectable neighboring device.

At operation 620, the electronic device may determine whether a response signal responding to the inquiry signal is received from the neighboring device.

If the electronic device determines that the response signal responding to the inquiry signal is not received form the neighboring device at operation 620, then the electronic device may proceed to operation 610 at which the electronic device may broadcast the inquiry signal to discover a neighboring device.

In contrast, if the electronic device determines that the response signal responding to the inquiry signal is received form the neighboring device at operation 620, then the electronic device may proceed to operation 630 at which a pairing connection is established. For example, in response to the response signal being received, the electronic device may be paired with the neighboring device having transmitted the response signal through an authentication process.

At operation 640, the electronic device may turn off a broadcasting operation or control a broadcasting cycle. For example, when the electronic device is paired with one neighboring device, the electronic device may turn off the operation of broadcasting the inquiry signal or control a cycle on which the inquiry signal is broadcasted. For example, when the electronic device is paired with one neighboring device, the electronic device may stop the broadcasting operation for searching for the neighboring device or control the broadcasting operation to operate on a relatively longer cycle than the configured cycle.

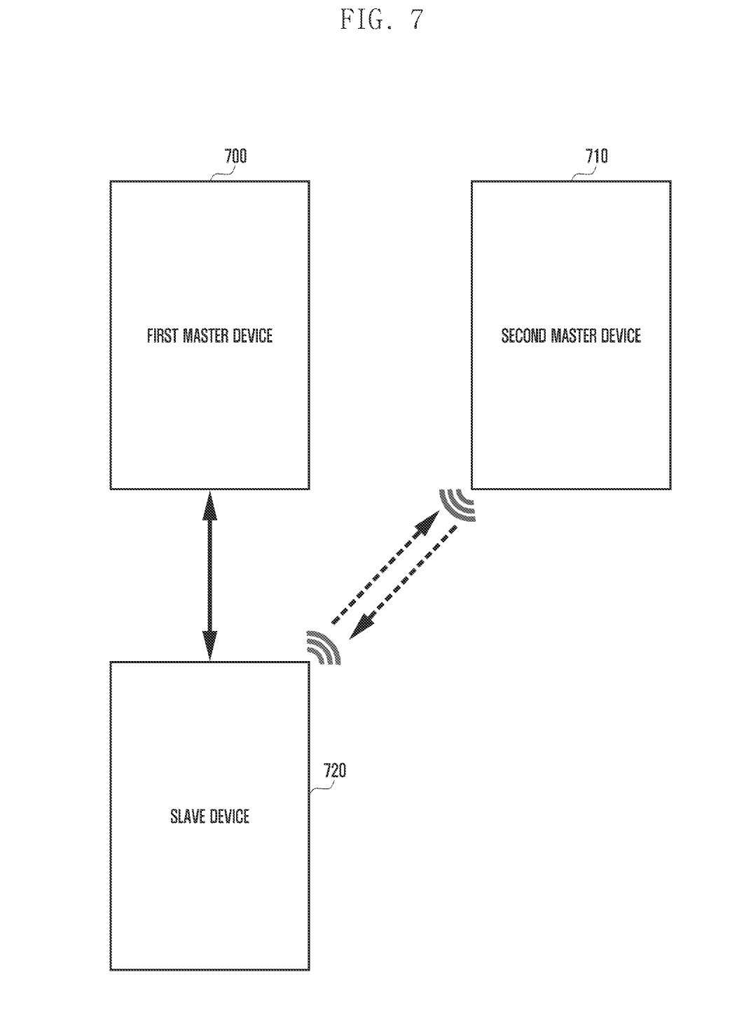

FIG. 7 schematically illustrates a configuration of a communication control system according to various embodiments of the present disclosure. For example, FIG. 7 illustrates a configuration of a short-range communication control system. Although the electronic device is classified into a master device and a slave device in FIG. 7, the electronic device according to various embodiments of the present disclosure may perform all functions of both the master device and the slave device.

Referring to FIG. 7, according to various embodiments of the present disclosure, the short-range communication control system may include electronic devices, for example, a first master device 700, a second master device 710, and a slave device 720 which form communication channels therebetween. Although only one slave device 720 is illustrated in FIG. 7, the number of slave devices is not limited thereto. For example, according to various embodiments of the present disclosure, many more slave devices 200 may be provided, and accordingly, the first master device 700 and the second master device 710 may discover a plurality of slave devices 720 when searching for communication connection devices.

According to various embodiments of the present disclosure, the first master device 700 and the second master device 710 are search (inquiry) devices for searching for (inquiring about) a neighboring device for a communication connection and the slave device 720 is a standby device which informs of the existence thereof, receives a signal transmitted from a neighboring electronic device, and performs a scan to respond. The slave device 720 may be a wearable electronic device which can be worn on a user's body, such as a smart watch, smart glasses, or the like, or an accessory electronic device, such as earphones, a wireless keyboard, and/or the like.

According to various embodiments of the present disclosure, the slave device 720 may also search for a neighboring device for a pairing connection and make a request for the pairing connection to the found neighboring device.

According to various embodiments of the present disclosure, the slave device 720 may activate the scan operation of the Bluetooth communication module on a predetermined cycle (e.g., every 1.28 sec). The slave device 720 may maintain a signal standby state for a predetermined time on a predetermined cycle. When the predetermined time passes, the slave device 720 may enter a standby state. When an inquiry signal is received (e.g., in response to receiving the inquiry signal), the slave device 720 may transmit an inquiry response signal to the first master device 700 or the second master device 700 in response to the inquiry signal.

When the first master device 700 and the second master device 710 receive the inquiry response signal corresponding to a response to the inquiry signal (e.g., in response to the first master device 700 and the second master device 710 receiving the inquiry response signal), the first master device 700 and the second master device 710 may be connected to at least one slave device 720 through a pairing process.

According to various embodiments of the present disclosure, when the pairing connection between the slave device 720 and the first master device 700 is made (e.g., in response to the pairing connection being established), the slave device 720 may stop the scan operation or configure the cycle of the scan operation to be longer than the preset cycle in order to prevent a connection with the second master device 710. According to various embodiments of the present disclosure, when the pairing connection between the slave device 720 and the first master device 700 is made (e.g., in response to the pairing connection being established), the slave device 720 may make a control to not transmit the inquiry response signal corresponding to the response to the inquiry signal received from the second master device 710.

According to various embodiments of the present disclosure, the slave device 720 may stop the scan operation when the paired first master device 700 is a preset private device and may perform the scan operation on a predetermined cycle when the paired first master device 700 is not the preset private device.

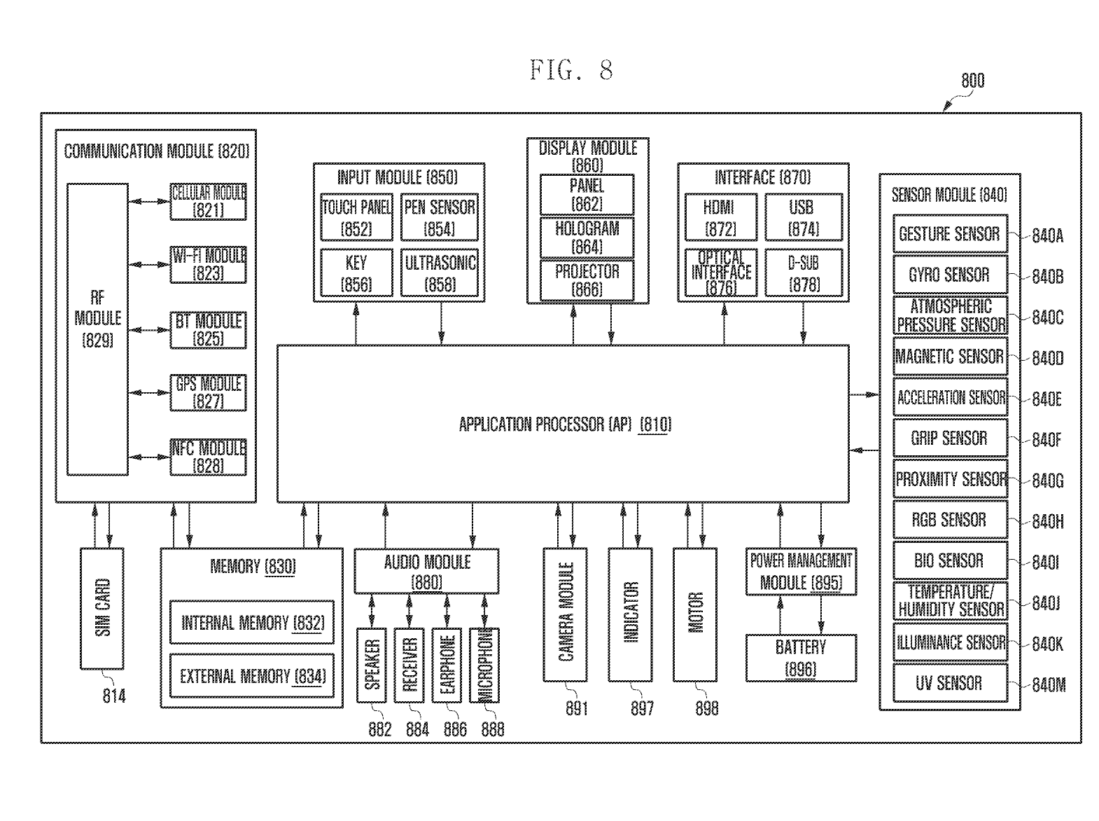

FIG. 8 is a block diagram illustrating a configuration of hardware according to an embodiment of the present disclosure.

Referring to FIG. 8, hardware 800 may be, for example, the electronic device 100 illustrated in FIG. 1. As illustrated in FIG. 8, the hardware 800 may include one or more application processors (AP) 810, a Subscriber Identification Module (SIM) card 814, a communication module 820, a memory 830, a sensor module 840, an input module 850, a display module 860, an interface 870, an audio module (e.g., audio coder/decoder (codec)) 880, a camera module 891, a power management module 895, a battery 896, an indicator 897, a motor 898 and any other similar and/or suitable components.

The AP 810 (e.g., the processor) may include one or more Application Processors (APs), or one or more Communication Processors (CPs).

The AP 810 may execute an Operating System (OS) or an application program, and thereby may control multiple hardware or software elements connected to the AP 810 and may perform processing and arithmetic operations on various data including multimedia data. The AP 810 may be implemented by, for example, a System on Chip (SoC). According to various embodiments of the present disclosure, the AP 810 may further include a Graphical Processing Unit (GPU) (not illustrated).

The SIM card 814 may be a card implementing a subscriber identification module, and may be inserted into a slot formed in a particular portion of the electronic device 100. The SIM card 814 may include unique identification information (e.g., Integrated Circuit Card IDentifier (ICCID)) or subscriber information (e.g., International Mobile Subscriber Identity (IMSI)).

The communication module 820 may be, for example, the communication module 160 illustrated in FIG. 1. The communication module 820 may include a Radio Frequency (RF) module 829. The communication module 820 may further include, for example, a cellular module 821, a Wi-Fi module 823, a Bluetooth (BT) module 825, a GPS module 827, a Near Field Communications (NFC) module 828. For example, the communication module 820 may provide a wireless communication function by using a radio frequency. Additionally or alternatively, the communication module 820 may include a network interface (e.g., a Local Area Network (LAN) card), a modulator/demodulator (modem), and/or the like for connecting the hardware 800 to a network (e.g., the Internet, a LAN, a Wide Area Network (WAN), a telecommunication network, a cellular network, a satellite network, a Plain Old Telephone Service (POTS), and/or the like).

The cellular module 821 may further include a Communication Processor (CP). The CP may control the transmission and reception of data by the communication module 820. As illustrated in FIG. 8, the elements such as the CP, the power management module 895, the memory 830, and the like are illustrated as elements separate from the AP 810. However, according to various embodiments of the present disclosure, the AP 810 may include at least some (e.g., the CP) of the above-described elements. The CP may manage a data line and may convert a communication protocol in the case of communication between the electronic device (e.g., the electronic device 100) including the hardware 200 and different electronic devices connected to the electronic device through the network.

The RF module 829 may be used for transmission and reception of data, for example, transmission and reception of RF signals or called electronic signals. Although not illustrated, the RF unit 829 may include, for example, a transceiver, a Power Amplifier Module (PAM), a frequency filter, a Low Noise Amplifier (LNA), and/or the like.

In addition, the RF module 829 may further include a component for transmitting and receiving electromagnetic waves in a free space in a wireless communication, for example, a conductor, a conductive wire, or the like.

The memory 830 may include an internal memory 832 and an external memory 834. The memory 830 may be, for example, the memory 130 illustrated in FIG. 1. According to various embodiments of the present disclosure, internal memory 832 may include, for example, at least one of a volatile memory (e.g., a Dynamic Random Access Memory (DRAM), a Static RAM (SRAM), a Synchronous Dynamic RAM (SDRAM), and/or the like), and a non-volatile memory (e.g., a One Time Programmable Read-Only Memory (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, and/or the like). According to various embodiments of the present disclosure, the internal memory 832 may be in the form of a Solid State Drive (SSD). The external memory 834 may further include a flash drive, for example, a Compact Flash (CF), a Secure Digital (SD), a Micro-Secure Digital (Micro-SD), a Mini-Secure Digital (Mini-SD), an extreme Digital (xD), a memory stick, and/or the like.

The sensor module 840 may include, for example, at least one of a gesture sensor 840A, a gyro sensor 840B, an atmospheric pressure sensor 840C, a magnetic sensor 840D, an acceleration sensor 840E, a grip sensor 840F, a proximity sensor 840G, a Red, Green and Blue (RGB) sensor 840H, a biometric sensor 840I, a temperature/humidity sensor 840J, an illuminance sensor 840K, and a Ultra Violet (UV) sensor 840M. The sensor module 840 may measure a physical quantity and/or may detect an operating state of the electronic device 100, and may convert the measured or detected information to an electrical signal. Additionally/alternatively, the sensor module 840 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), a fingerprint sensor (not illustrated), and/or the like. Additionally or alternatively, the sensor module 840 may include, for example, an E-nose sensor (not illustrated), an EMG sensor (not illustrated), an EEG sensor (not illustrated), an ECG sensor (not illustrated), a fingerprint sensor, and/or the like. The sensor module 840 may further include a control circuit (not illustrated) for controlling one or more sensors included therein.

The input module 850 may include a touch panel 852, a pen sensor 854 (e.g., a digital pen sensor), keys 856, and an ultrasonic input unit 858. The input module 850 may be, for example, the user input module 140 illustrated in FIG. 1. The touch panel 852 may recognize a touch input in at least one of, for example, a capacitive scheme, a resistive scheme, an infrared scheme, an acoustic wave scheme, and the like. In addition, the touch panel 852 may further include a controller (not illustrated). In the capacitive type, the touch panel 852 is capable of recognizing proximity as well as a direct touch. The touch panel 852 may further include a tactile layer (not illustrated). In this event, the touch panel 852 may provide a tactile response to the user.

The pen sensor 854 (e.g., a digital pen sensor), for example, may be implemented by using a method identical or similar to a method of receiving a touch input from the user, or by using a separate sheet for recognition. For example, a key pad or a touch key may be used as the keys 856.

The ultrasonic input unit 858 enables the terminal to detect a sound wave by using a microphone (e.g., a microphone 888) of the terminal through a pen generating an ultrasonic signal, and to identify data. The ultrasonic input unit 858 is capable of wireless recognition. According to various embodiments of the present disclosure, the hardware 800 may receive a user input from an external device (e.g., a network, a computer, a server, and/or the like), which is connected to the communication module 830, through the communication module 830.

The display module 860 may include a panel 862, a hologram 864, a projector 866, and/or the like. The display module 860 may be, for example, the display module 150 illustrated in FIG. 1. The panel 862 may be, for example, a Liquid Crystal Display (LCD) and an Active Matrix Organic Light Emitting Diode (AM-OLED) display, and/or the like. The panel 862 may be implemented so as to be, for example, flexible, transparent, or wearable. The panel 862 may include the touch panel 852 and one module. The hologram 864 may display a three-dimensional image in the air by using interference of light. According to various embodiments of the present disclosure, the display module 860 may further include a control circuit for controlling the panel 862 or the hologram 864.

The interface module 870 may include an High-Definition Multimedia Interface (HDMI) module 872, a Universal Serial Bus (USB) module 874, an optical interface module 876, a D-subminiature (D-SUB) module 878, and/or the like. Additionally or alternatively, the interface 870 may include, for example, one or more interfaces for Secure Digital (SD)/MultiMedia Card (MMC) (not shown) or Infrared Data Association (IrDA) (not shown). The interface module 870 or any of its sub-modules may be configured to interface with another electronic device (e.g., an external electronic device), an input device, an external storage device, and/or the like.

The audio module 880 may encode/decode voice into electrical signal, and vice versa. The audio module 880 may, for example, encode/decode voice information that are input into, or output from, a speaker 882, a receiver 884, an earphone 886, and/or a microphone 888.

The camera module 891 may capture still images or video. According to various embodiments of the present disclosure, the camera module 891 may include one or more image sensors (e.g., front sensor module or rear sensor module; not shown), an Image Signal Processor (ISP, not shown), or a flash Light-Emitting Diode (flash LED, not shown).

The power management module 895 may manage electrical power of the hardware 800. Although not shown, the power management module 895 may include, for example, a Power Management Integrated Circuit (PMIC), a charger Integrated Circuit (charger IC), a battery fuel gauge, and/or the like.

The PMIC, for example, may be disposed in an integrated circuit or an SoC semiconductor. The charging method for the hardware 800 may include wired or wireless charging. The charger IC may charge a battery, or prevent excessive voltage or excessive current from a charger from entering the hardware 800. According to various embodiments of the present disclosure, the charger IC may include at least one of a wired charger IC or a wireless charger IC. The wireless charger IC may be, for example, a magnetic resonance type, a magnetic induction type or an electromagnetic wave type, and may include circuits such as, for example, a coil loop, a resonance circuit or a rectifier.

The battery gauge may measure, for example, a charge level, a voltage while charging, a temperature of battery 896, and/or the like. The battery 896 may supply power to, for example, the hardware 800. The battery 896 may be, for example, a rechargeable battery.

The indicator 897 may indicate one or more states (e.g., boot status, message status or charge status) of the hardware 800 or a portion thereof (e.g., the AP 811). The motor 898 may convert electrical signal into mechanical vibration. MCU 899 may control the sensor module 840.

Although not illustrated, the hardware 800 may include a processing unit (e.g., a Graphics Processing Unit (GPU)) for supporting a module TV. The processing unit for supporting a module TV may process media data according to standards such as, for example, Digital Multimedia Broadcasting (DMB), Digital Video Broadcasting (DVB), media flow, and/or the like.

According to various embodiments of the present disclosure, each of the above-described elements of the hardware 800 may include one or more components, and the name of the relevant element may change depending on the type of electronic device. According to various embodiments of the present disclosure, the hardware 800 may include at least one of the above-described elements. Some of the above-described elements may be omitted from the hardware 800, or the hardware 800 may further include additional elements. In addition, according to various embodiments of the present disclosure, some of the elements of the hardware 800 may be combined into one entity, which may perform functions identical to those of the relevant elements before the combination.

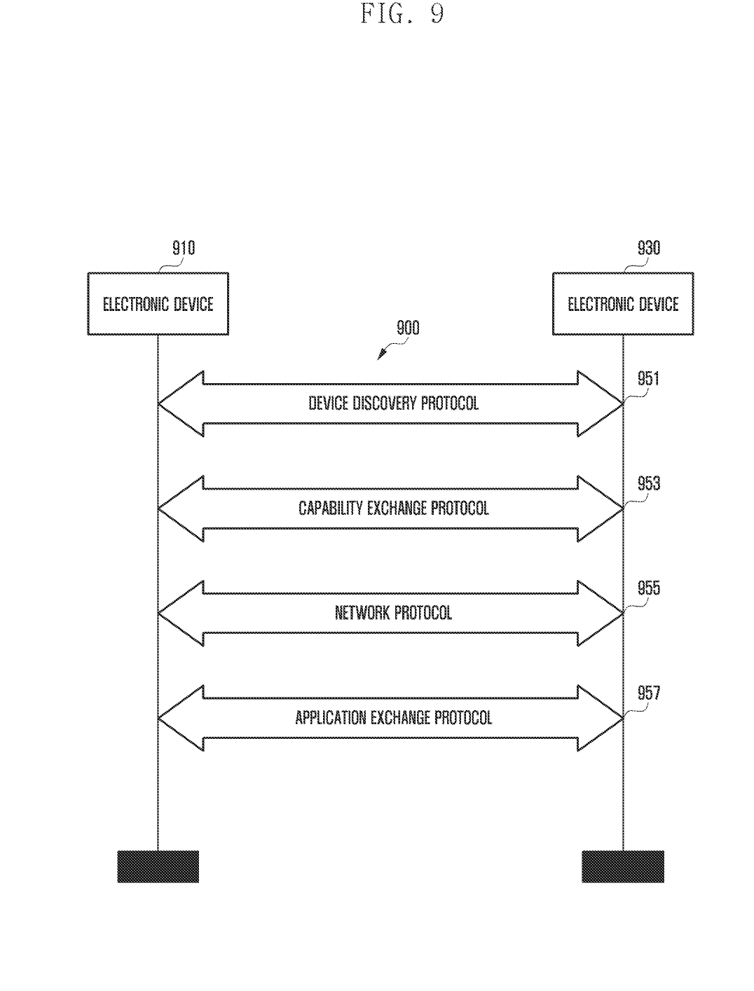

FIG. 9 illustrates a communication protocol between a plurality of electronic devices according to various embodiments of the present disclosure. For example, FIG. 9 illustrates a communication protocol 910 between an electronic device 910 and an electronic device 930 according to various embodiments of the present disclosure.

Referring to FIG. 9, the communication protocol 900 may include a device discovery protocol 951, a capability exchange protocol 953, a network protocol 955, and an application protocol 957.

The device discovery protocol 951 may be a protocol that allows the electronic devices (e.g., the electronic device 910 or the electronic device 930) to detect an external electronic device which can be connected thereto through short-range communication or connects the found external electronic device thereto. For example, the electronic device 910 (e.g., the electronic device 100) may detect the electronic device 930 (e.g., the electronic device 104) as a device, which can communicate with the electronic device 910, through a short-range communication method (e.g., Bluetooth and/or the like) using the device discovery protocol 951. The electronic device 910 may acquire and store identification information of the electronic device 930 detected through the device discovery protocol 951 for a communication connection with the electronic device 930. For example, the electronic device 910 may establish the communication connection with the electronic device 930 at least based on the identification information. The device discovery protocol 951 may be a protocol for authenticating a plurality of electronic devices. For example, the electronic device 910 may perform an authentication between the electronic device 910 and the electronic device 930 based on communication information (e.g., a Media Access Control (MAC) address, a Universally Unique IDentifier (UUID), a SubSystem IDentification (SSID), and an Information Provider (IP) address) for the connection with the electronic device 930.

The capability exchange protocol 953 may be a protocol for exchanging information related to a service function which can be supported by at least one of the electronic device 910 and the electronic device 930. For example, the electronic device 910 and the electronic device 930 may exchange information related to a service function currently provided by each of the electronic device 910 and the electronic device 930 through the capability exchange protocol 953. The information which can be exchanged between the electronic devices may include identification information indicating a particular service among a plurality of services which can be supported by the electronic device 910 and the electronic device 930. For example, the electronic device 910 may receive, from the electronic device 930, identification information of a particular service provided by the electronic device 930 through the capability exchange protocol 953. In this case, the electronic device 910 may determine whether the electronic device 910 can support the particular service based on the received identification information.

The network protocol 955 may be a protocol for controlling flows of data which is transmitted/received to provide a service linked between the electronic devices (e.g., the electronic device 910 and the electronic device 930) which are connected to communicate with each other. For example, at least one of the electronic device 910 and the electronic device 930 may control an error or data quality by using the network protocol 955. Additionally or alternatively, the network protocol 955 may determine a transport format of data transmitted/received between the electronic device 910 and the electronic device 930. Further, at least one of the electronic device 910 and the electronic device 930 may at least manage a session (e.g., connect or terminate a session) for a data exchange between the electronic devices by using the network protocol 955.

The application protocol 957 may be a protocol for providing a process or information for exchanging data related to a service provided to an external electronic device. For example, the electronic device 910 (e.g., the electronic device 100) may provide a service to the electronic device 930 (e.g., the electronic device 104 or the server 106) through the application protocol 957.

The communication protocol 900 may include a standard communication protocol, a communication protocol designated by an individual or organization (e.g., a communication protocol self-designated by a communication device manufacturing company or a network supplying company) or a combination thereof.

The term “module” used in embodiments of the present disclosure may refer to, for example, a “unit” including one of hardware, software, and firmware, or a combination of two or more thereof. The term “module” may be interchangeable with a term such as a unit, a logic, a logical block, a component, or a circuit. The “module” may be a minimum unit of an integrated component or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments of the present disclosure, at least some of the devices (e.g., modules or functions thereof) or the method (e.g., operations) according to the present disclosure may be implemented by a command stored in a non-transitory computer-readable storage medium in a programming module form. When the command is executed by one or more processors (e.g., the processor), the one or more processors may execute a function corresponding to the command. The non-transitory computer-readable storage medium may be, for example, the memory 130. At least a part of the programming module may be implemented (e.g., executed) by, for example, the processor 210. At least a part of the programming module may include, for example, a module, a program, a routine, a set of instructions, and/or a process for performing one or more functions.

The non-transitory computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (e.g., programming module), such as a Read Only Memory (ROM), a Random Access Memory (RAM), a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present disclosure, and vice versa.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a short-range communication module configured to transmit/receive a short-range communication signal to/from at least one neighboring device; and
a control module configured to control, when a pairing connection with a first neighboring device is established through the short-range communication module, at least one of turning on/off of a scan operation for waiting for reception of a signal from at least one second neighboring device and configuring a cycle of the scan operation.

2. The electronic device of claim 1, wherein, when the electronic device is paired with the first neighboring device, the control module generates a control to at least one of stop the scan operation and not respond to an inquiry signal of the second neighboring device.

3. The electronic device of claim 1, wherein, when the electronic device is paired with the first neighboring device, the control module configures the cycle of the scan operation to be relatively longer than a preset scan cycle.

4. The electronic device of claim 1, wherein the control module determines whether the first neighboring device is a private device.

5. The electronic device of claim 4, wherein the control module controls turning on/off of the scan operation or the cycle of the scan operation in response to determining that the first neighboring device is the private device, and generating a control to perform the scan operation on a predetermined cycle in response to determining that the first neighboring device is not the private device.

6. The electronic device of claim 5, wherein the control module generates a control to not transmit an inquiry response signal to the second neighboring device if an inquiry signal is received from the second neighboring device in response to determining that the first neighboring device is the private device, and generates a control to transmit the inquiry response signal to the second neighboring device in response to determining that the second neighboring device is not the private device.

7. A method of controlling a short-range communication connection by an electronic device, the method comprising:
establishing a pairing connection with a first neighboring device; and
generating at least one of a control to stop a scan operation for waiting for reception of a signal from at least one second neighboring device, a control to configure a cycle of the scan operation when the pairing connection with the first neighboring device is established.

8. The method of claim 7, wherein the generating of the control to stop the scan operation comprises:
generating control to at least one of not transmit an inquiry response signal to the second neighboring device and configure the cycle of the scan operation to be relatively longer than a preset scan cycle.

9. An electronic device comprising:
a short-range communication module configured to transmit/receive a short-range communication signal to/from at least one neighboring device; and
a control module configured to control, when a pairing connection with a first neighboring device is established through the short-range communication module, at least one of turning on/off of a broadcasting operation of broadcasting a signal to search for a neighboring device and configuring a cycle of the broadcasting operation.

10. The electronic device of claim 9, wherein the control module generates a control to at least one of stop the broadcasting operation and configure the cycle of the broadcasting operation to be longer than a preset cycle.

11. The electronic device of claim 9, wherein the control module determines whether the first neighboring device is a private device.

12. The electronic device of claim 11, wherein the control module controls turning on/off of the broadcasting operation or the cycle of the broadcasting operation in response to determining that the first neighboring device is a private device.

13. A method of controlling a short-range communication connection by an electronic device, the method comprising:
establishing a pairing connection with a first neighboring device; and
at least one of:
stopping a broadcasting operation of broadcasting an inquiry signal to search for a neighboring device, and
controlling a cycle of the broadcasting operation when the pairing connection with the first neighboring device is established.

14. The method of claim 13, wherein the at least one of the stopping of the broadcasting operation of broadcasting the inquiry signal to search for the neighboring device and the controlling of the cycle of the broadcasting operation comprises:
configuring the cycle of the broadcasting operation to be relatively longer than a preset broadcasting cycle.

15. The method of claim 13, wherein the at least one of the stopping of the broadcasting operation of broadcasting the inquiry signal to search for the neighboring device and the controlling of the cycle of the broadcasting operation comprises:
at least one of, in response to determining that the first neighboring device is a private device, stopping the broadcasting operation and controlling the cycle of the broadcasting operation.

16. A non-transitory computer-readable storage medium storing instructions that, when executed, cause at least one processor to perform the method of claim 7.

17. A non-transitory computer-readable storage medium storing instructions that, when executed, cause at least one processor to perform the method of claim 13.
